(19) United States
(12) Patent Application Publication
(10) Pub. No.: US 2023/0329255 A1
(43) Pub. Date: Oct. 19, 2023

(54) VACUUM DRYING A COMESTIBLE CELL-BASED MEAT PRODUCT

(71) Applicant: Upside Foods, Inc., Berkeley, CA (US)

(72) Inventor: Morgan Laurence Rease, Emeryville, CA (US)

(21) Appl. No.: 18/298,019

(22) Filed: Apr. 10, 2023

Related U.S. Application Data
(60) Provisional application No. 63/363,002, filed on Apr. 14, 2022.

(51) Int. Cl. F26B 5/12; A23B 4/03; F26B 25/22; A23B 4/06

(52) U.S. Cl. CPC A23B 4/03; A23B 4/06; F26B 5/12; F26B 25/225

(57) ABSTRACT

The present disclosure relates to one or more vacuum drying methods and apparatuses to partially dry a comestible cell-based meat product after being harvested from a bioreactor. The vacuum drying method includes implementing a pressure-temperature environment to evaporate a portion of the moisture content from a comestible cell-based meat product. In doing so, the vacuum drying method can concentrate protein in the comestible cell-based meat product, as well as minerals and other non-liquid components. Specifically, at refrigeration temperatures, the vacuum drying method preserves cellular structure of the comestible cell-based meat product and facilitates safe processing according to various rules and regulations for raw meat sale, distribution, and consumer consumption. In addition, lowered environmental pressure provides reduced drying times to achieve a particular moisture content criteria or threshold mass of the comestible cell-based meat product. Once partially dried, the comestible cell-based meat product can be subsequently processed for raw meat packaging.

### CROSS REFERENCE TO RELATED APPLICATIONS

This application claims priority to, and the benefit of, U.S. Provisional Pat. Application No. 63/363,002, filed Apr. 14, 2022, which is incorporated herein by reference in its entirety.

### BACKGROUND

Lab-grown, cultivated, or cultured meat belongs to the emerging field of cellular agriculture and represents a promising technology for delivering products that have so far been produced through slaughter of livestock or domesticated game. This technological innovation aims to offer a possibility of reducing the negative effects of conventional meat production techniques on humans, animals, and the environment. With these advancements, myriad different challenges have also presented themselves. For example, producing cultured meat that is ready for packaging and consumer interaction is particularly challenging. Indeed, after being harvested from a bioreactor, cultured meat typically comprises a wet, soft, and malleable consistency and texture that is not suitable for raw meat packaging. Moreover, in its wet, soft, and malleable state following harvest, cultured meat cannot provide the desired consumer expectations. That is, handling, cooking, and eating cultured meat with too much moisture provides an undesirable consumer experience-thereby falling short of consumer expectations associated with a typical raw slab of conventional meat. Therefore, there is a need for methods and apparatuses for reducing moisture content from the cultured meat following harvest to facilitate subsequent raw meat packaging and favorable consumer interactions.

The subject matter claimed herein is not limited to embodiments that solve any disadvantages or that operate only in environments such as those described above. Rather, this background is only provided to illustrate one example technology area where some embodiments described herein may be practiced.

### BRIEF SUMMARY

Embodiments of the present disclosure include one or more methods and apparatuses of vacuum drying a comestible cell-based meat product. In a vacuum apparatus under vacuum conditions, water is evaporated from the comestible cell-based meat product and evacuated (leading to shortened drying times). Additionally, under refrigerated conditions (as opposed to freezing, ambient or elevated temperatures), the comestible cell-based meat product can be safely processed. For example, unlike ambient or elevated temperatures, refrigerated vacuum conditions avoid denaturing proteins (e.g., cooking) and minimizes the introduction of air-borne microbes or food-borne pathogens to the comestible cell-based meat product. Further, unlike freeze drying, refrigerated conditions avoid tissue damage (e.g., undesirable changes to raw/cooked qualities) based on undergoing freeze/thaw cycles. In addition, the vacuum-based drying method disclosed herein reduces moisture content to a semi-dry level (i.e., partial desiccation). This is different from most drying methods like jerky-processing that dry the product completely, or at least to the point where product preservation (i.e., spoilage prevention) is achieved.

In particular embodiments, the disclosed vacuum drying process includes: 1) inserting the comestible meat-based product into a vacuum apparatus; and 2) partially drying the comestible cell-based meat product (i) at a refrigeration temperature, (ii) under vacuum, and (iii) until satisfying a moisture content criteria or a threshold mass (or a predetermined amount of drying time lapses).

Additional or alternative embodiments are also herein contemplated. Indeed, various features, steps, and/or advantages of one or more embodiments of the present disclosure are outlined in the following description.

### BRIEF DESCRIPTION OF THE DRAWINGS

The detailed description provides one or more embodiments with additional specificity and detail through the use of the accompanying drawings, as briefly described below.

FIG. 1 illustrates a process flow for implementing vacuum drying via a vacuum apparatus to manufacture a comestible cell-based meat product in accordance with one or more embodiments.

FIG. 2 illustrates a process flow for vacuum drying a comestible cell-based meat product in accordance with one or more embodiments.

FIG. 3 illustrates a process of estimating a threshold mass for a comestible cell-based meat product and determining a mass of the comestible cell-based meat product satisfies the threshold mass to stop the drying process in accordance with one or more embodiments.

FIG. 4A illustrates a process of estimating a predetermined amount of time for partially drying a comestible cell-based meat product and determining a drying time duration satisfies the predetermined amount of time to stop the drying process in accordance with one or more embodiments.

FIGS. 4B-4C illustrate graphs showing mass versus drying time for a vacuum drying process of a comestible cell-based meat product for determining learned drying times in accordance with one or more embodiments.

FIG. 5 illustrates a process of determining that a comestible cell-based meat product satisfies a moisture content criteria to trigger stoppage of a vacuum drying process in accordance with one or more embodiments.

FIGS. 6A-6B illustrate a vacuum apparatus for partially drying a comestible cell-based meat product in accordance with one or more embodiments.

FIGS. 7A-7B illustrate flowcharts of a series of steps for vacuum drying a comestible cell-based meat product in accordance with one or more embodiments.

### DETAILED DESCRIPTION

This disclosure describes one or more embodiments of a vacuum drying method and apparatus to partially dry a comestible cell-based meat product after being harvested from a bioreactor. In one or more embodiments, the vacuum drying method implements a combined pressure-temperature manipulation to evaporate a portion of the moisture content from a comestible cell-based meat product. In doing so, the vacuum drying method can concentrate protein in the comestible cell-based meat product, as well as minerals and other non-liquid components. Specifically, at refrigeration temperatures, the vacuum drying method preserves cellular structure of the comestible cell-based meat product and facilitates safe processing according to various rules and regulations for raw meat sale, distribution, and consumer consumption. In addition, lowered environmental pressure provides reduced drying times to achieve a particular moisture content criteria or threshold mass of the comestible cell-based meat product. Once partially dried, the comestible cell-based meat product can be subsequently processed for raw meat packaging and consumer cooking.

As just mentioned, in one or more embodiments, the vacuum drying method comprises inserting a comestible cell-based meat product into a vacuum apparatus for pressure-temperature manipulation. The vacuum apparatus includes various different components. In certain embodiments, the vacuum apparatus includes a drying tray. The drying tray may be sized and configured to hold a comestible cell-based meat product harvested from a bioreactor. For example, the drying tray comprises a size and shape to fit a sheet of comestible cell-based meat product harvested from a substrate used to grow the comestible cell-based meat product inside a bioreactor. Additionally, or alternatively, the drying tray may be sized and shaped to fit inside a vacuum chamber of the vacuum apparatus. In certain implementations, the drying tray comprises a food grade material (e.g., stainless steel). In some embodiments, the drying tray further comprises perforations or pores through which moisture can be evacuated.

In addition, the vacuum apparatus comprises a vacuum chamber. When enclosed, the vacuum chamber may be hermetically sealed. Using this seal (and other elements, such as a vacuum pump), the vacuum apparatus can cause the vacuum chamber to provide a desired temperature and pressure. For example, the vacuum apparatus causes the vacuum chamber to provide a refrigeration temperature for a comestible cell-based meat product inside the vacuum chamber. Additionally, for example, the vacuum apparatus causes the vacuum chamber to lower an environmental pressure for the comestible cell-based meat product inside the vacuum chamber. In one or more embodiments, the vacuum apparatus manipulates the pressure of the vacuum chamber to correspondingly regulate a temperature of the comestible cell-based meat product. Indeed, as the vacuum apparatus causes the pressure of the vacuum chamber to decrease, the boiling point of water likewise decreases-thereby causing water evaporation and heat removal from the comestible cell-based meat product.

Further, the vacuum apparatus comprises a vacuum pump. The vacuum pump evacuates moisture and air from the vacuum chamber. For example, in certain embodiments, the vacuum pump sucks moisture and air out of the vacuum chamber via a controlled outlet (e.g., a valve). It will be appreciated that, in particular implementations, the vacuum pump can be power operated, provide single or multi-stage vacuum draw, and provide a myriad of different flow rates.

With such a vacuum apparatus, the vacuum drying method of the present disclosure includes partially drying the comestible cell-based meat product until certain criteria are satisfied. In particular embodiments, the vacuum drying method comprises drying the comestible cell-based meat product until a mass of the comestible cell-based meat product satisfies a threshold mass. In certain implementations, the threshold mass is based, at least partially, on an initial mass of the comestible cell-based meat product prior to vacuum drying. In addition, the threshold mass may be based on a measured or learned pre-drying moisture-to-solid-content ratio (e.g., a mass ratio indicative of moisture content at time of harvest) and/or an estimated post-drying moisture-to-solid content ratio (e.g., a mass ratio indicative of moisture content after the vacuum drying process).

Additionally, or alternatively, the vacuum drying method comprises drying the comestible cell-based meat product until a predetermined amount of time for drying the comestible cell-based meat product lapses. In particular embodiments, the predetermined amount of time for drying the comestible cell-based meat product may be based on a learned rate of moisture removal associated with drying the comestible cell-based meat product. The learned rate of moisture removal may correspond to historical observation, machine-learning model predictions, etc. Further, in one or more embodiments, the predetermined amount of time for drying the comestible cell-based meat product may be based on an initial mass of the comestible cell-based meat product prior to vacuum drying. Additionally, or alternatively, the predetermined amount of time for drying the comestible cell-based meat product may be surface area dependent, temperature dependent, humidity dependent, pressure dependent, etc.

In one or more embodiments, the vacuum drying method comprises drying the comestible cell-based meat product until a moisture content criteria is satisfied. In certain implementations, the moisture content criteria is satisfied when the comestible cell-based meat product satisfies a threshold mass. In other implementations, the moisture content criteria is satisfied when the comestible cell-based meat product is dried for a predetermined amount of time. Additionally, or alternatively, the moisture content criteria is satisfied when the comestible cell-based meat product measures one or more moisture metrics. For example, the moisture content criteria is satisfied when the comestible cell-based meat product measures a certain moisture-to-solid-content ratio. As another example, the moisture content criteria is satisfied when the vacuum apparatus evacuates a certain volume of moisture from the comestible cell-based meat product.

The vacuum drying methods and vacuum apparatuses as disclosed herein can provide various advantages over prior methods and systems. In particular, the vacuum drying methods of the present disclosure are advantageous from a food safety perspective. Indeed, meat safety rules and regulations (e.g., per regulating bodies such as the US Department of Agriculture) require that raw meat for commercial sale and distribution be kept no higher than predefined temperatures for a certain period of time. Unlike many vacuum drying methods in the art that would impermissibly violate these safety standards, the vacuum drying methods disclosed herein maintain the comestible cell-based meat product at a refrigeration temperature during a vacuum drying process. Such a refrigeration temperature comports with meat safety rules and regulations.

Similarly, the vacuum drying methods of the present disclosure preserve the uncooked meat quality and cell structure of the comestible cell-based meat product. Some conventional drying methods heat or smoke meat such that the meat begins to cook (particularly heat-sensitive proteins). Similarly, some methods in the art freeze dry meat (or other foods). These approaches can be less than optimal for a comestible cell-based meat product due to degradation often caused by these conventional approaches. Indeed, the disclosed vacuum drying methods of the present disclosure prevent cooking of the comestible cell-based meat product so that, post-drying, the comestible cell-based meat product mimics a raw (uncooked) slab of conventional meat. Further, the disclosed vacuum drying methods of the present disclosure prevent freezing of the comestible cell-based meat product. Freeze-thaw cycles for drying a comestible cell-based meat product can result in cell structure damage to the comestible cell-based meat product, in addition to undesirable changes in raw/cooked texture quality. Accordingly, the disclosed vacuum drying methods include drying a comestible cell-based meat product at refrigeration temperatures instead of cooking temperatures or freezing temperatures.

Further, the disclosed vacuum drying methods can improve texture of the comestible cell-based meat product. For example, removing excess moisture and air pockets also helps the comestible cell-based meat product remain at a desirable density during cooking by minimizing opportunities for steam to create pockets/spongey textures. Similarly, the disclosed vacuum drying methods can provide a firmer texture to the comestible cell-based meat product to better mimic a raw slab of conventional meat.

Additionally, the disclosed vacuum drying methods are advantageous for the application of a comestible cell-based meat product. Some conventional drying processes (e.g., for jerky) dry the product completely, or at least to the point where product preservation (i.e., spoilage prevention) is achieved. Such conventional approaches are unsuitable for a comestible cell-based meat product. Indeed, conventional approaches to remove all or most moisture could ruin the uncooked and cooked qualities of a comestible cell-based meat product. By contrast, the disclosed vacuum drying methods provide partial desiccation by reducing moisture content until satisfying a threshold moisture criteria (e.g., that is approximately that of a raw slab of conventional meat). In other embodiments, the disclosed vacuum drying methods provide partial desiccation by reducing moisture content until a comestible cell-based meat product has been under vacuum for a predetermined amount of time or until a mass of the comestible cell-based meat product satisfies a threshold mass.

In addition, the disclosed vacuum drying methods can improve drying times over conventional drying processes. For example, conventional drying at lower temperatures lends to excessively long drying times, which are ill-suited for scaling production of a comestible cell-based meat product. In contrast, the disclosed vacuum drying methods can comparatively shorten drying times while under vacuum by rapidly lowering the boiling point of water to evaporate moisture from the comestible cell-based meat product at a refrigeration temperature. The disclosed approach therefore lends to increased manufacturing friendliness and scalability.

The disclosed vacuum drying methods can also improve certain qualities of a comestible cell-based meat product. For example, the disclosed vacuum drying method can remove both gases and moisture content from a comestible cell-based meat product. In doing so, volatiles responsible for odors can be removed. Similarly, air bubbles can be removed from a comestible cell-based meat product. Such gas removal can lend to a comestible cell-based meat product with more consistent meat density (e.g., fewer or no air pockets). As another example, the disclosed vacuum drying method can avoid lipid oxidation typical of some conventional drying methods. Specifically, by implementing a vacuum apparatus, the disclosed vacuum drying methods prevent (or at least slows down) oxidative degradation that causes undesirable color changes in a comestible cell-based meat product. In yet another example of quality improvement, the disclosed vacuum drying methods allow easier chemical manipulation of the comestible cell-based meat product. For instance, transglutaminase or other binding agents perform better after the comestible cell-based meat product has been vacuum dried because excess moisture can counteract such agents (or render them ineffective or negligible)—lending to loose, non-cohesive meat.

As illustrated by the foregoing discussion, the present disclosure utilizes a variety of terms to describe features and benefits of the disclosed vacuum drying methods and associated vacuum apparatus. Additional detail is now provided regarding the meaning of these terms. For example, as used herein, the term “comestible cell-based meat product” refers to a cell mass composed of non-human cells grown within a bioreactor. In certain embodiments, a comestible cell-based meat product comprises a cultured cell mass composed of at least one type of non-human muscle-derived cell. In particular embodiments, a comestible cell-based meat product comprises one or more of myoblasts, mesoangioblasts, myofibroblasts, myotubes, mesenchymal stem cells, hepatocytes, fibroblasts, pericytes, adipocytes, adipose tissue, epithelial, chondrocytes, osteoblasts, osteoclasts, pluripotent cells, somatic stem cells, endothelial cells, epithelial tissue, vascular endothelium, contractile cells, or muscle-derived cells. It will be appreciated that, in certain implementations, a comestible cell-based meat product comprises a combination of two or more of the foregoing types of cells and/or tissue (e.g., a combination of muscle-derived cells and skin-based cells). Further, in some embodiments, a comestible cell-based meat product comprises one or more cells from livestock (e.g., cattle, bison, sheep, pigs), poultry (e.g., chicken, duck, goose), game (e.g., elk, bear, rabbit, snake, pheasant), or aquatic animal species (e.g., fish, frog, shark). It will be appreciated that a comestible cell-based meat product can comprise various different forms or configurations (e.g., a suspension, an adherent cell culture, etc.).

Additionally, as used herein, the terms “partially dry” or “partially dried” refer to partial desiccation or semi-dehydration of a comestible cell-based meat product. Indeed, partially drying excludes completely drying a comestible cell-based meat product, in addition to excluding drying of the comestible cell-based meat product to the point of spoilage prevention (e.g., a jerky-like state). In particular embodiments, partially drying refers to moisture reduction in a comestible cell-based meat product until the point at which the comestible cell-based meat product satisfies a certain criteria (e.g., a threshold moisture content, a threshold mass, or a threshold drying time). For example, partially drying a comestible cell-based meat product comprises vacuum drying the comestible cell-based meat product until the comestible cell-based meat product measures a moisture-to-solid-content ratio of about 2 to about 10 grams of moisture per one gram of solid content. The term “solid content” refers to non-water components of a comestible cell-based meat product. For example, solid content can include protein, fats, carbohydrates, cells, tissue, or other non-water components of a cell mass composed of non-human cells grown within a bioreactor.

As used herein “wet basis moisture content” refers to the water content of a comestible cell-based meat product. In particular, “wet basis moisture content” refers to the ratio of the weight of water to the total weight of the material. Wet basis moisture content can be expressed as a percentage between 0 percent and 100 percent. For example, a comestible cell-based meat product having 10 grams of solid content and 90 grams of moisture has a wet basis moisture content of 90% (e.g., 9 grams of moisture for every 1 gram of other components (e.g., solid content).

Further, as used herein, the term “refrigeration temperature” refers to a cooled temperature that is above the freezing point of water. In particular embodiments, a refrigeration temperature refers to a temperature that slows a growth of food-borne pathogens (e.g., per food safety regulations). For example, a refrigeration temperature comprises a temperature between 0 and 10° C. In a preferred example, a refrigeration temperature is above 0° C. and at or below 5° C. Alternatively, the refrigeration temperature may refer to between -2° C. to 15° C. It should be noted that the liquid range of water is expanded by solubilized salts and other materials, e.g., suppressing freezing temperature to below 0C.

Additionally, as used herein, the term “under vacuum” refers to reduced pressure conditions for a comestible cell-based meat product. In particular embodiments, under vacuum refers to a pressure that corresponds to the steam phase for water when at a refrigeration temperature. For example, under vacuum refers to an environmental pressure (e.g., within a vacuum chamber) of about one Torr (or 1/760 atm). As another example, under vacuum refers to an environmental pressure of about .001 atm to about .95 atm. In particular embodiments, under vacuum refers to an environmental pressure of about .006 atm to about .0086 atm.

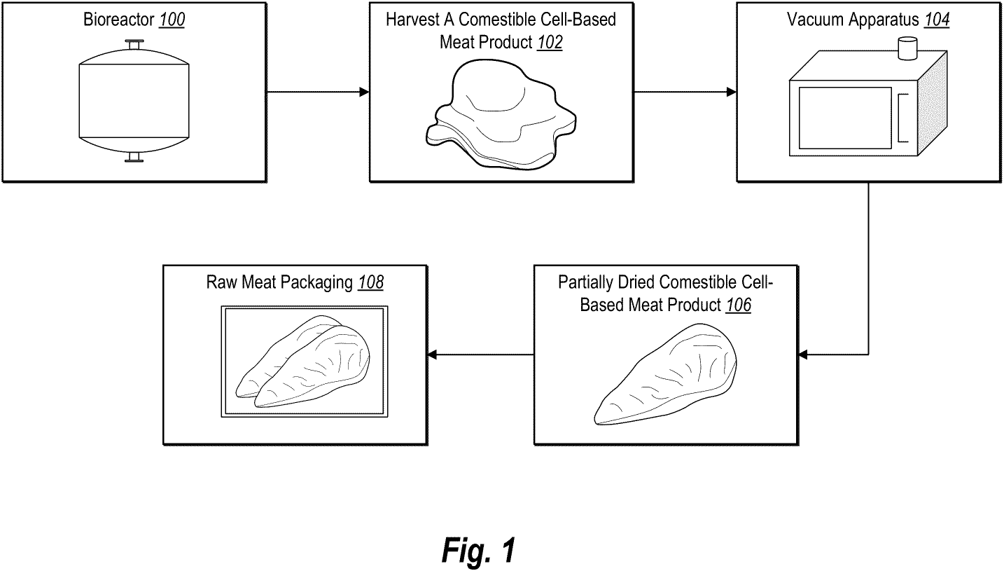

Turning to the figures, FIG. 1 illustrates a process flow for implementing vacuum drying via a vacuum apparatus to manufacture a comestible cell-based meat product in accordance with one or more embodiments. As shown in FIG. 1, the process flow begins with a bioreactor 100. As shown, the bioreactor 100 comprises an inlet and an outlet configured for fluid transmission. In some embodiments, the inlet and the outlet are directional such that fluid proceeds into the bioreactor 100 via the inlet and out of the bioreactor 100 via the outlet. In other embodiments, the inlet and the outlet are not directional such that fluid flow is reversable. Additional or alternative implementations of a bioreactor are disclosed in U.S. Pat. Pub. No. 2021/0145031 A1, entitled APPARATUSES AND METHODS FOR PREPARING A MEAT PRODUCT, filed on Nov. 20, 2020, (hereafter, the “‘031 Publication”), the contents of which are expressly incorporated herein by reference.

In one or more embodiments, the bioreactor 100 comprises an internal cavity or enclosure sized and shaped for housing a substrate on which a comestible cell-based meat product is grown. In some embodiments, the internal cavity or enclosure of the bioreactor 100 comprises a volume between about 25 liters and about 20,000 liters. In particular embodiments, the bioreactor 100 comprises an internal volume of about 500 liters.

Additionally, it will be appreciated that the bioreactor 100 can be oriented in a variety of ways. For example, in some embodiments, the bioreactor 100 may be oriented at a vertical offset (e.g., as disclosed in the ‘031 Publication). In other embodiments, the bioreactor 100 may be oriented horizontally or at a horizontal offset. Still, in other embodiments, the bioreactor 100 may be oriented based on a certain process being performed (e.g., seeding, harvesting, cleaning, etc.). Additionally, or alternatively, the bioreactor 100 may be oriented based on a substrate form factor or substrate configuration.

Once the comestible cell-based meat product grows to a predetermined size or for a predetermined duration, the comestible cell-based meat product is removed from the bioreactor 100 via a harvest step 102. Specifically, the harvest step 102 comprises removing the comestible cell-based meat product from a substrate that was positioned inside the bioreactor 100 during the growth stage of the comestible cell-based meat product. For example, at the harvest step 102, the substrate is removed from the bioreactor 100, and a high-velocity fluid flow and/or biophysical methods are applied to at least one of the substrate or the comestible cell-based meat product. In certain implementations, the harvest step 102 comprises removing, from the substrate, a sheet of comestible cell-based meat product connected or grown together.

It will be appreciated that the moisture content of the comestible cell-based meat product upon harvest may be relatively high compared to conventional raw meat. This can be due, at least in part, to the amount of moisture needed to grow the comestible cell-based meat product (and in certain cases, from the high-velocity fluid flow to harvest the comestible cell-based meat product). As an example, the moisture content of the comestible cell-based meat product after being harvested at the harvest step 102 measures a moisture-to-solid-content ratio of about 10 grams to about 20 grams of moisture per one gram of solid-content.

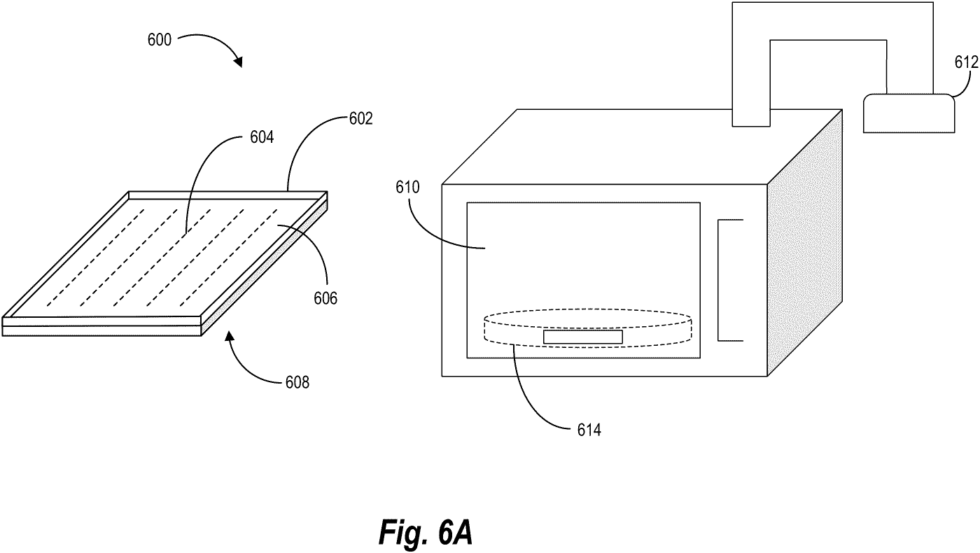

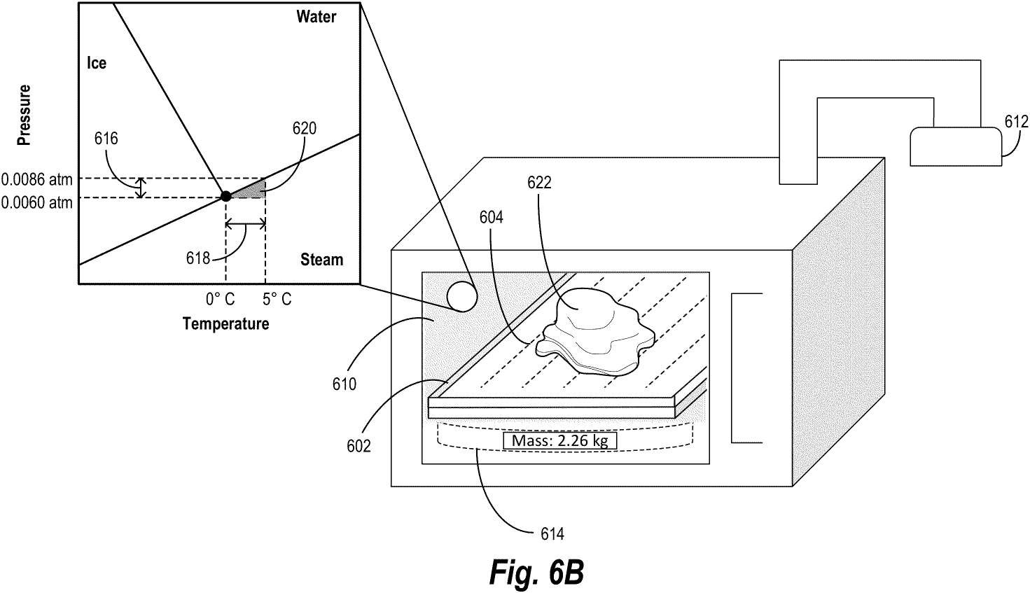

Accordingly, and as discussed above, this moisture content in the comestible cell-based meat product may be too high for subsequent raw meat packaging and favorable consumer interactions. Therefore, the process flow illustrated in FIG. 1 comprises providing the harvested comestible cell-based meat product to a vacuum apparatus 104 for partial drying. The vacuum apparatus 104 comprises a drying tray for positioning the comestible cell-based meat product onto a surface of the drying tray. In addition, the vacuum apparatus 104 comprises a vacuum chamber for receiving the drying tray. The vacuum chamber of the vacuum apparatus 104 is configured to hermetically seal and place the comestible cell-based meat product under vacuum. The vacuum apparatus 104 further comprises a vacuum pump to evacuate moisture from the vacuum chamber. Additional detail of these (and additional or alternative) components of the vacuum apparatus 104 are further described below in relation to FIGS. 6A-6B.

In particular, the vacuum apparatus 104 lowers the environmental pressure around the comestible cell-based meat product. By dropping the environmental pressure around the comestible cell-based meat product, the vacuum apparatus 104 can correspondingly drop (or maintain) a temperature of the comestible cell-based meat product at a refrigeration temperature. Specifically, the vacuum apparatus 104 can manipulate the pressure around the comestible cell-based meat product to lower the water boiling point such that water evaporates, which is a cooling process, from the comestible cell-based meat product. In doing so, the vacuum apparatus 104 removes both heat and moisture from the comestible cell-based meat product for safe, effective moisture reduction.

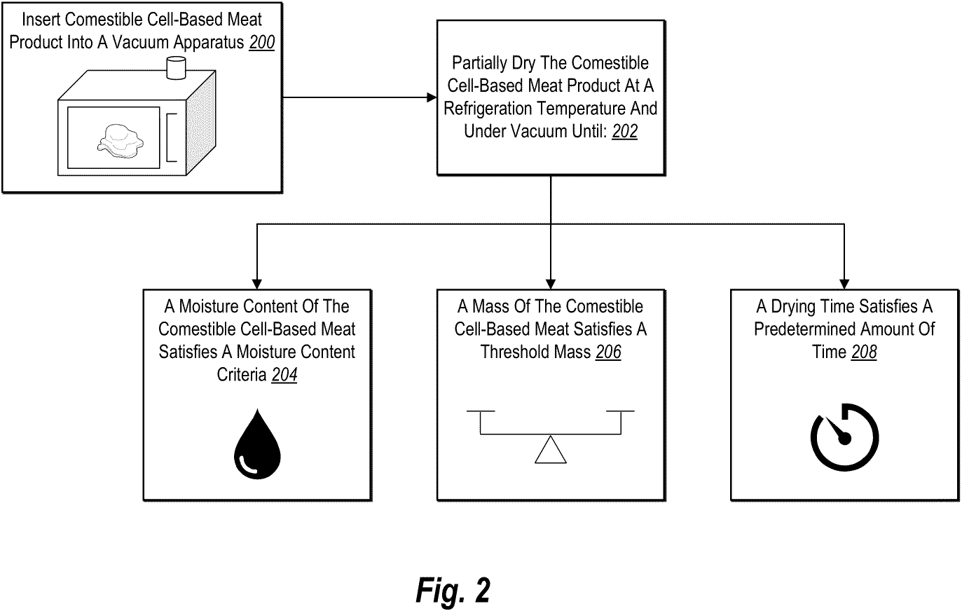

In one or more embodiments, the vacuum apparatus 104 maintains the comestible cell-based meat product at a refrigeration temperature and under vacuum until certain criteria are satisfied. These criteria are described below in relation to FIG. 2 and subsequent figures. In this manner, the vacuum apparatus 104 generates a partially dried comestible cell-based meat product 106. It will be appreciated that, in one or more embodiments, the partially dried comestible cell-based meat product 106 comprises a moisture content similar to a slab of conventional raw meat. Moreover, the partially dried comestible cell-based meat product 106 advantageously comprises additional qualities imparted by the vacuum apparatus 104 (e.g., improved texture as described above).

At a raw meat packaging step 108, the partially dried comestible cell-based meat product 106 can be further prepared for commercial sale and distribution as a raw meat product to be cooked (and consumed). In particular embodiments, the raw meat packaging step 108 comprises vacuum wrapping or shrink wrapping the partially dried comestible cell-based meat product 106. In other embodiments, the raw meat packaging step 108 comprises filling a tube with the partially dried comestible cell-based meat product 106, forcing air out, bringing the tube into close contact with the partially dried comestible cell-based meat product 106, and closing the tube. This tube-packaging process, as an example, is similarly performed for making sausage rolls, wherein a sausage casing may be placed over tube.

It will be appreciated that the raw meat packaging step 108 can include packaging the partially dried comestible cell-based meat product 106 with an absorption pad (e.g., to prevent pooling of meat liquids). Further, in one or more embodiments, the raw meat packaging step 108 comprises providing additives or agents (e.g., binders or preservatives) to the partially dried comestible cell-based meat product 106. Examples of such additives or agents include transglutaminase, starches, protein isolates, carbohydrates, sodium caseinate, gelatin, teitolin, veginate, texite, nitrates, nitrites, carrageenan, tertiary butylhydroquinone, phosphate additives, propyl gallate, pthallates, spices, flavors, fats, etc. Additionally, or alternatively, the raw meat packaging step 108 comprises injecting the partially dried comestible cell-based meat product 106 with flavoring additives or agents (e.g., essential oil, oleoresin, essence or extractive, protein hydrolysate, distillate, or any product of roasting, heating or enzymolysis).

As discussed above, the vacuum drying methods of the present disclosure include partially drying a comestible cell-based meat product until certain criteria are satisfied. In accordance with one or more embodiments, FIG. 2 illustrates a process flow for vacuum drying a comestible cell-based meat product.

As shown at a step 200 in FIG. 2, the comestible cell-based meat product is inserted into a vacuum apparatus. For example, at the step 200, the comestible cell-based meat product is harvested from a bioreactor and corresponding substrate. Once harvested, the comestible cell-based meat product is positioned onto a surface of a drying tray. The drying tray is placed and hermetically sealed inside a vacuum chamber of the vacuum apparatus.

At a step 202, the vacuum apparatus is utilized to partially dry the comestible cell-based meat product at a refrigeration temperature and under vacuum until certain criteria are met. Indeed, the vacuum apparatus partially dries the comestible cell-based meat product at a refrigeration temperature and under vacuum until a moisture content of the comestible cell-based meat product satisfies a moisture content criteria 204. In one or more embodiments, the moisture content criteria 204 includes a desired amount (or range of amounts) of water or other liquids for a comestible cell-based meat product. In particular embodiments, the moisture content criteria 204 comprises a threshold moisture-to-solid-content ratio (or range of ratios). For example, the moisture content criteria 204 comprises a threshold moisture-to-solid-content ratio of about 2 grams to about 10 grams of moisture per one gram of solid-content.

Additionally, or alternatively, the vacuum apparatus partially dries the comestible cell-based meat product at a refrigeration temperature and under vacuum until a mass of the comestible cell-based meat product satisfies a threshold mass 206. In one or more embodiments, the threshold mass 206 comprises a desired or estimated mass (or range of masses) for a comestible cell-based meat product. For example, the threshold mass 206 comprises a desired mass that is dependent on the initial (post-harvest) mass of the comestible cell-based meat product. For example, a batch of comestible cell-based meat with an initial mass of 125 g and an initial wet basis moisture content of 88% would be dried to a threshold mass of 51 g and an estimated/calculated wet basis moisture content of about 70%.

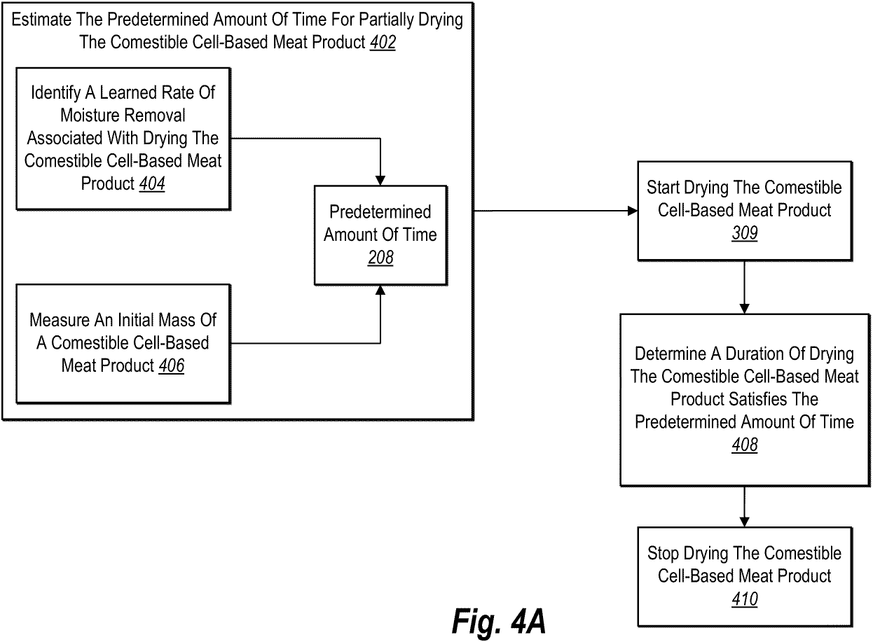

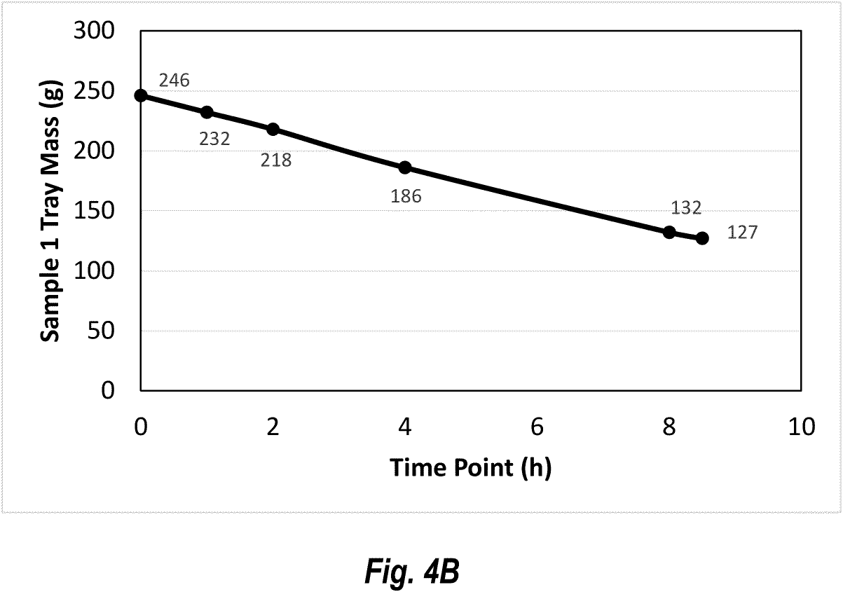

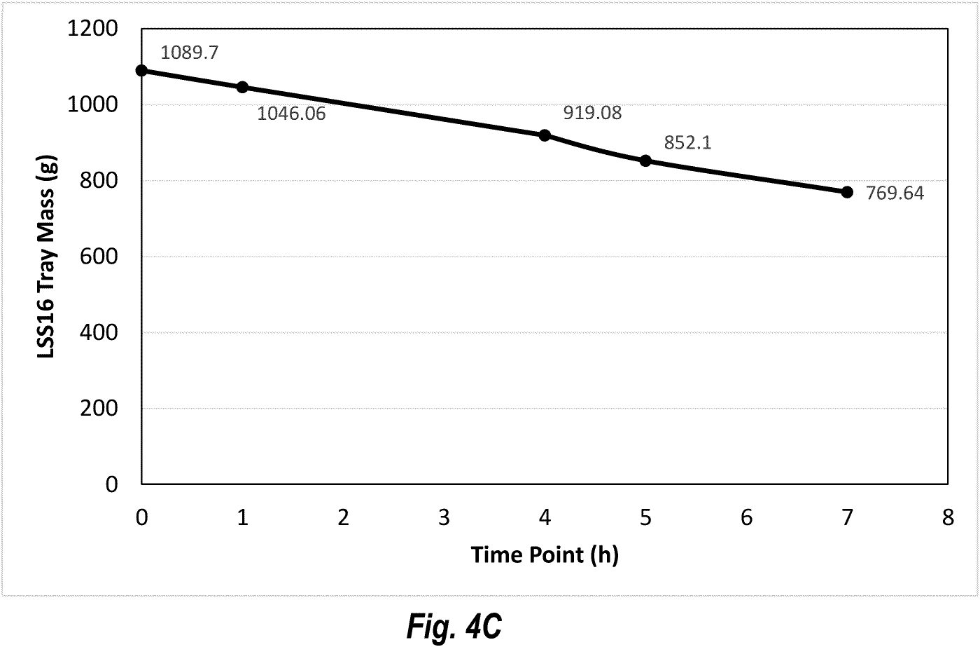

Additionally, or alternatively, the vacuum apparatus partially dries the comestible cell-based meat product at a refrigeration temperature and under vacuum until a drying time satisfies a predetermined amount of time 208. In one or more embodiments, the predetermined amount of time 208 comprises a learned drying time. For example, the predetermined amount of time comprises a drying time that corresponds to a learned drying rate per mass of comestible cell-based meat product. In particular, FIGS. 4B and 4C describe learned drying times for example comestible cell-based meat products.

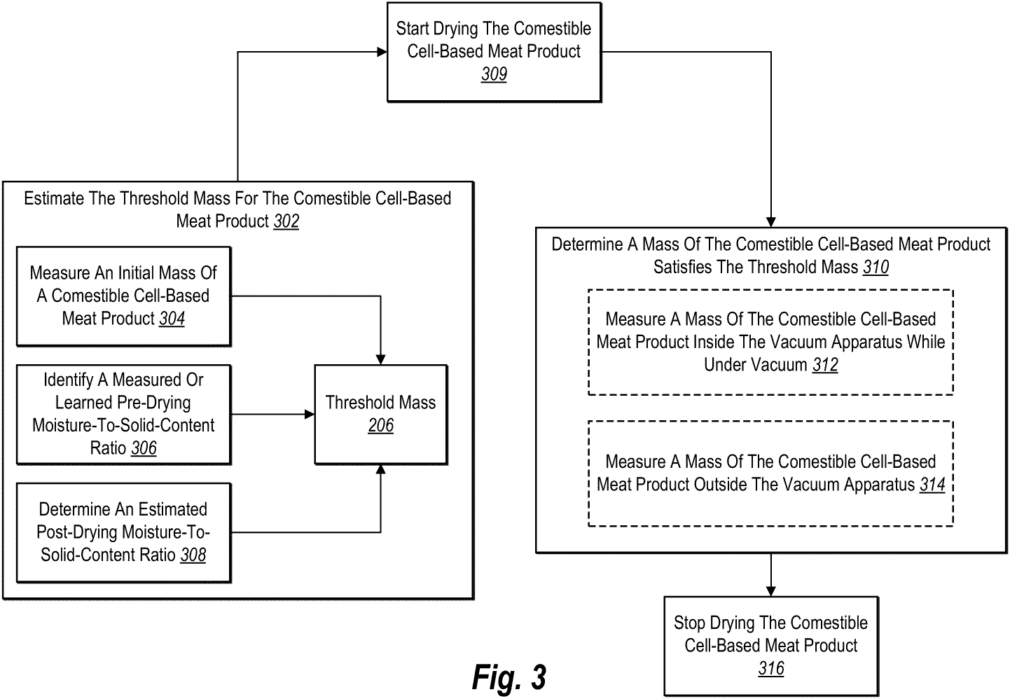

In one or more embodiments, it will be appreciated that the vacuum apparatus can partially dry the comestible cell-based meat product until multiple criteria are satisfied (as will be described below). Each of the moisture content criteria 204, the threshold mass 206, and the predetermined amount of time 208 are described more below in relation to FIGS. 3-5.

As just mentioned, in one or more embodiments, a threshold mass is utilized to determine when to stop vacuum drying a comestible cell-based meat product. In accordance with one or more embodiments, FIG. 3 illustrates a process of estimating a threshold mass for a comestible cell-based meat product and determining a mass of the comestible cell-based meat product satisfies the threshold mass to stop the drying process.

At a step 302 of FIG. 3, the threshold mass 206 for the comestible cell-based meat product is estimated. To estimate the threshold mass 206, steps 304-308 are performed. Each is discussed in turn. For the step 304, an initial mass of the comestible cell-based meat product is measured. The initial mass of the comestible cell-based meat product corresponds to the amount of mass in the comestible cell-based meat product upon harvest from a bioreactor. In certain implementations, the initial mass of the comestible cell-based meat product also measures the mass of the drying tray on which the comestible cell-based meat product resides. In such cases, the mass of the drying tray can be tared (i.e., subtracted or zeroed out).

The initial mass of the comestible cell-based meat product can be measured utilizing one or more scales that measure mass. Additionally, or alternatively, the initial mass of the comestible cell-based meat product can be measured utilizing one or more scales that measure weight (e.g., the force of gravity on the mass of the comestible cell-based meat product). Examples of scales (or corresponding components) include food grade scales, industrial scales, ultra precision scales, bench scales, platform scales, floor scales, spring scales, hydraulic scales, load cells, strain gauges, high resolution balances, digital scientific balances, beam balances, etc.

At the step 306, a measured or learned pre-drying moisture-to-solid-content ratio is identified. For example, in one or more embodiments, identifying a measured pre-drying moisture-to-solid-content ratio comprises determining (upon harvest) the quantity of moisture in the harvested comestible cell-based meat product in relationship to the quantity of solid content (e.g., meat protein, fats, carbohydrates, ash etc.), expressed as X parts (or percent) of moisture for each part (or percent) of solid content. To illustrate, identifying the pre-drying moisture-to-solid-content ratio comprises determining an amount of water or moisture (e.g., in grams) per a predetermined amount of solid-content (e.g., one gram of solid-content). Alternatively, at step 306 a measured or learned pre-drying moisture-to-protein ratio is identified. For instance, identifying a measured pre-drying moisture-to-protein ratio comprises determining (upon harvest) the quantity of moisture in the harvested comestible cell-based meat product in relationship to the quantity of protein, expressed as X parts (or percent) of moisture for each part (or percent) of protein.

It will be appreciated that precisely identifying the pre-drying moisture-to-moisture-to-solid-content ratio comprises using lab-based analytic approaches. Additionally, or alternatively, identifying the pre-drying moisture-to-solid-content ratio comprises using one or more moisture gauges, moisture meters, moisture analyzers (e.g., a halogen moisture analyzer), near infrared analyzers, diode array analyzers, etc. to obtain a measurement reading of the harvested comestible cell-based meat product (or a sample thereof). Accordingly, in one or more embodiments, a sample of the harvested comestible cell-based meat product is placed inside a moisture analyzer that quickly and effectively measures a pre-drying moisture-to-solid-content ratio via one or more weighing-heating cycles of the sample. In alternative implementations, as explained below in relation to step 310, rather than directly determining moisture content (or ratios) utilizing one or more of the above-identified instruments or tools, the method involves determining or estimating moisture content based on a proportion of mass lost to evaporation during the vacuuming drying.

Alternative to measuring the pre-drying moisture-to-solid-content ratio, the step 306 can include identifying a learned pre-drying moisture-to-solid-content ratio for the harvested comestible cell-based meat product. For example, in one or more embodiments, identifying a learned pre-drying moisture-to-solid-content ratio comprises utilizing a historical average of pre-drying moisture-to-solid-content ratios for comestible cell-based meat products. For instance, over X amount of comestible cell-based meat product harvests, the average pre-drying moisture-to-solid-content ratio observed may be in the range of about 10 to about 20 (e.g., 10:1-20:1).

As another example, identifying a learned pre-drying moisture-to-solid-content ratio comprises utilizing a machine-learning model trained to predict a pre-drying moisture-to-solid-content ratio upon harvest. For instance, given certain variables, the machine-learning model can predict a pre-drying moisture-to-solid-content ratio for a harvested comestible cell-based meat product. Such variables may include mass, density, volume, the type of comestible cell-based meat product, an amount of time grown in a bioreactor, an amount and/or type of cell media used to feed the comestible cell-based meat product inside the bioreactor, the type of method utilized to harvest the comestible cell-based meat product, the type and/or configuration of a substrate used to grow the comestible cell-based meat product, etc.

At a step 308, an estimated post-drying moisture-to-solid-content ratio is determined. In one or more embodiments, determining the estimated post-drying moisture-to-solid-content ratio comprises identifying a desired moisture-to-solid-content ratio following a vacuum drying process of the present disclosure. For example, the estimated post-drying moisture-to-solid-content ratio for a particular type of comestible cell-based meat product (e.g., a cell-based breast of chicken) corresponds to a user expectation of or actual moisture-to-solid-content ratio for a corresponding conventional slab of meat product being imitated (e.g., a chicken breast of a slaughtered chicken). To illustrate, the estimated post-drying moisture-to-solid-content ratio of the comestible cell-based meat product after being partially dried is in a range of about 2 to about 10 (e.g., 2:1-10:1).

As another example, the estimated post-drying moisture-to-solid-content ratio for a particular type of comestible cell-based meat product corresponds to desired (e.g., surveyed, observed, predicted) meat qualities. These meat qualities can relate to or affect the consumer experiences of packaging, storing, buying, cooking, freezing, thawing, and/or eating the comestible cell-based meat product. Additionally, or alternatively, the estimated post-drying moisture-to-solid-content ratio can affect food labeling (e.g., food product dating, quality dates, etc.). Accordingly, the estimated post-drying moisture-to-solid-content ratio for a particular type of comestible cell-based meat product can be influenced by these and/or other factors just described.

The threshold mass 206 is estimated based on one or more of the initial mass, the pre-drying moisture-to-solid-content ratio, or the post-drying moisture-to-solid-content ratio of the comestible cell-based meat product discussed above. In certain embodiments, the threshold mass 206 is based on each of the initial mass, the pre-drying moisture-to-solid-content ratio, and the post-drying moisture to solid-content ratio of the comestible cell-based meat product. For example, in certain implementations, the threshold mass 206 is determined according to function (1) below:

$$T h r e s h o l d M a s s = I n i t i a l M a s s ∗ \left(\frac{1 - p r e D r y i n g m o i s t u r e c o n t e n t w e t b a s i s}{1 - p o s t d r y i n g m o i s t u r e c o n t e n t w e t b a s i s}\right) \qquad \text{(1)}$$

where Threshold Mass represents the threshold mass 206, InitialMass represents the measured initial mass at the step 304,

$$\left(\frac{1 - p r e D r y i n g m o i s t u r e c o n t e n t w e t b a s i s}{1 - p o s t - d r y i n g m o i s t u r e c o n t e n t w e t b a s i s}\right)$$

represents the quotient of the estimated pre-drying moisture content wet basis and the measured post-drying moisture content wet basis, and the operator “*” represents scalar multiplication.

It will be appreciated, however, that other embodiments within the scope of this disclosure include utilizing the initial mass, the pre-drying moisture-to-solid-content ratio, and/or the post-drying moisture-to-solid-content ratio of the comestible cell-based meat product in myriad other ways to estimate the threshold mass 206. For example, in one or more embodiments, the initial mass may be utilized in conjunction with a loss-on-drying curve to estimate the threshold mass 206. A loss-on-drying curve represents the loss on drying as a function of time, temperature, and/or other factors (where mass changes over time until achieving a steady-state mass reading). In particular, loss on drying is the loss of weight or mass expressed as percentage resulting from water and volatile matter of any kind that can be driven off (e.g., evaporated) under specified conditions.

Further, in one or more embodiments, a computing device performs one or more of the foregoing steps. For example, a computing device automatically estimates the threshold mass 206 in response to identifying the initial mass, the pre-drying moisture-to-solid-content ratio, and/or the post-drying moisture-to-solid-content ratio of the comestible cell-based meat product.

At a step 309, the vacuum drying process is initiated. For example, at the step 309, the comestible cell-based meat product is sealed inside the vacuum chamber of a vacuum apparatus. In addition, the vacuum apparatus begins operation to lower the environmental pressure around the comestible cell-based meat product inside the vacuum chamber. As the environmental pressure around the comestible cell-based meat product decreases, the boiling point of water likewise decreases. Evaporation of moisture from the comestible cell-based meat product thus begins (thereby cooling or maintaining the comestible cell-based meat product to a refrigeration temperature).

At a step 310, a mass of the comestible cell-based meat product is determined to satisfy the threshold mass 206. To determine the mass of the comestible cell-based meat product satisfies the 206, one of step 312 or step 314 is performed. At the step 312, a mass of the comestible cell-based meat product is measured inside the vacuum apparatus while under vacuum. In particular embodiments, the mass of the comestible cell-based meat product is measured at predetermined intervals (e.g., every 10 seconds, 30 seconds, 1 minute, 5 minutes, 10 minutes, a half hour, an hour, or hours, etc.). In other embodiments, the mass of the comestible cell-based meat product is measured at a continuous (or near-continuous) basis. The same (or similar) device used to measure the initial mass of the comestible cell-based meat product at the step 304 can be implemented for performing the step 310.

For example, at the step 312, a device for measuring the mass of the comestible cell-based meat product while inside the vacuum chamber under vacuum can visually display (e.g., via a digital readout) a measurement reading of the mass through a viewing window of the vacuum chamber. Additionally, or alternatively, the device for measuring the mass of the comestible cell-based meat product can transmit a measurement reading of the mass to an external computing device while the mass measurement device is inside the vacuum chamber under vacuum. To do so, one or more communication methods may be implemented, such as a BLUETOOTH® connection, WIFI connection, near-field communication, ZIGBEE® communication, Z-WAVE® communication, 6LoWPAN communication, cellular (e.g., LTE) connection, etc.

It will be appreciated that in certain implementations of the step 312, the inside-chamber device for measuring the mass of the comestible cell-based meat product can be battery powered. Alternatively, in one or more embodiments, the inside-chamber device for measuring the mass is configured to receive power from an external power source outside of the vacuum chamber (e.g., without disrupting operation of the vacuum apparatus).

Alternatively to the step 312, the step 314 can be performed. The step 314 comprises measuring a mass of the comestible cell-based meat product outside the vacuum apparatus. The step 314 can be performed in a same or similar manner as performed for the step 304 discussed above. For example, in one or more embodiments of the step 314, the vacuum chamber is taken out of vacuum by virtue of being opened, unsealed, or flooded with gas. The drying tray of the comestible cell-based meat product can be removed from inside the vacuum chamber and placed onto a measuring device for measuring the mass of the comestible cell-based meat product. If the measured mass does not satisfy the threshold mass 206, the drying tray can be placed back into the vacuum chamber and the vacuum drying process continued. This pause-and-measure process can be repeated until the measured mass of the comestible cell-based meat product satisfies the threshold mass 206.

In either of the step 312 or the step 314, the measured mass is compared to the threshold mass 206 to determine whether the measured mass satisfies the threshold mass 206. For example, upon receiving a mass measurement reading, a computing device can automatically compare the mass measurement reading to the threshold mass 206. In one or more embodiments, the mass measurement reading of the comestible cell-based meat product satisfies the threshold mass 206 if the mass measurement reading is less than or equal to the threshold mass 206. In other embodiments, the mass measurement reading of the comestible cell-based meat product satisfies the threshold mass 206 if the mass measurement reading is within a percentage value of the threshold mass 206.

At a step 316, the vacuum drying process is stopped in response to determining the mass of the comestible cell-based meat product satisfies the threshold mass 206. In one or more embodiments, the step 316 is an automated step. For example, a computing device performing the step 310 can correspondingly cause the vacuum apparatus to stop operation and trigger the vacuum chamber to be taken out of vacuum. For instance, the computing device can cause the vacuum apparatus to actuate one or more pressure regulators to flood the vacuum chamber with atmospheric gas. Alternatively, the step 316 is not automated. For example, the vacuum drying apparatus is manually stopped and brought out of vacuum. Upon ending the vacuum drying process, the partially-dried comestible cell-based meat product is removed from the vacuum chamber and corresponding drying tray in preparation for subsequent processing (e.g., raw meat packaging).

As mentioned above, in one or more embodiments, a predetermined amount of time is utilized to determine when to stop vacuum drying a comestible cell-based meat product. In accordance with one or more embodiments, FIGS. 4 illustrates a process of estimating a predetermined amount of time for partially drying a comestible cell-based meat product and determining a drying time duration satisfies the predetermined amount of time to stop the drying process.

At a step 402 of FIGS. 4, the predetermined amount of time 208 for partially drying the comestible cell-based meat product is estimated. To estimate the predetermined amount of time 208, steps 404-406 are performed. Each is discussed in turn. For the step 404, a learned rate of moisture removal associated with drying the comestible cell-based meat product is identified. In one or more embodiments, a learned rate of moisture removal comprises an amount of moisture removed from a comestible cell-based meat product as a function of time. In certain embodiments, the learned rate of moisture removal comprises an amount of moisture removed from a comestible cell-based meat product as a function of time and one or more additional factors, such as mass, temperature, pressure, humidity, or exposed surface area.

It will be appreciated that the learned rate of moisture removal can be generated in one or more different ways. In particular embodiments, the learned rate of moisture removal is generated using historical moisture removal data (e.g., sample moisture readings taken at predetermined time intervals throughout a vacuum drying process of the present disclosure). For example, a comestible cell-based meat product of X kilograms at an assumed constant refrigeration temperature and under vacuum may correspond to a first set of moisture readings (e.g., moisture-to-protein measurements) taken at Y-minute time intervals. Similarly, a comestible cell-based meat product of Z kilograms at an assumed constant refrigeration temperature and under vacuum may correspond to a second set of moisture readings taken at Y-minute time intervals. Based on such a plurality of observed moisture readings and corresponding factor(s) (e.g., mass, temperature, pressure, humidity, exposed surface area), a learned rate of moisture removal can be generated. For example, an average rate of moisture removal can be generated. For more precise rates of moisture removal, rates of moisture removal can be interpolated between a specific subset of observed data.

In one or more embodiments, the step 404 of identifying the learned rate of moisture removal is based on an initial mass of the comestible cell-based meat product. With the initial mass of the comestible cell-based meat product, a corresponding learned rate of moisture removal can be identified. For example, a computing device may retrieve an observed rate of moisture removal that provides the closest fit based on the initial mass of the comestible cell-based meat product. As another example, a computing device may interpolate (or predict via a machine-learning model) mass-time drying curves that are specific to the measured initial mass of the comestible cell-based meat product to generate a corresponding learned rate of moisture removal.

In connection with the step 404, at a step 406, the initial mass of the comestible cell-based meat product can be measured. The step 406 of measuring the initial mass of the comestible cell-based meat product is the same as (or similar to) the step 304 described above in relation to FIG. 3.

In one or more alternative embodiments, it will be appreciated that other factors (e.g., temperature, pressure, humidity, or exposed surface area) can also influence identification of the correct learned rate of moisture removal for the comestible cell-based meat product at the step 404. Accordingly, in one or more embodiments, the step 406 comprises measuring an initial temperature of the comestible cell-based meat product or measuring an amount of surface area from which moisture will be evacuated out of the comestible cell-based meat product. Additionally, or alternatively, the step 406 comprises identifying vacuum apparatus settings (e.g., the vacuum pressure and/or refrigeration temperature to be implemented inside the vacuum chamber). Based on these measurements and/or settings, the learned rate of moisture removal for partially drying the comestible cell-based meat product can be identified in a same or similar manner as discussed above.

As examples, FIGS. 4B and 4C illustrate graphs of vacuum drying times of comestible cell-based meat products from which learned rates of moisture removal are determined. In particular, the vacuum drying times vs. the mass of the comestible cell-based meat product were observed to learn rates of moisture removal. For the examples shown in FIGS. 4B and 4C, the comestible cell-based meat products were vacuum dried on trays. To determine the mass of the comestible cell-based meat product as it dries, the weight of the trays is predetermined. Prior to drying, the comestible cell-based meat product is accessed for moisture content. In one or more embodiments, moisture is determined as g/100 g or as a percentage. Specifically, an example moisture content is 90 g of moisture per 100 g of raw material or 90% moisture.

To learn a rate of moisture removal, a desired final moisture content is determined for a given desired end product. For example, 75 g of moisture per 100 g of raw material or 75% moisture is an example final moisture content. To determine when a product is done, the moisture content is determined based on a dry basis. As an example, if a starting material has 10 g of solids per 100 g (i.e., 10% solids), the moisture dry basis is 900% (9 g of moisture per 1 g of solids). In this example, the desired end product has 25 of solids per 100 g (25% solids). The moisture dry basis of the desired end product is 300% (3 g moisture per 1 g of solids). In an example with a starting mass of 1000 g, 100 g are solids and 900 g are moisture. Because the desired end product has a moisture dry basis of 300%, the desired end mass from 1000 g of starting material is 400 g as it is assumed that 100% of material that evaporates is moisture.

After the vacuum drying process starts, the process is periodically paused and the combined weight is recorded (tray and comestible cell-based meat product). In alternative implementations, the weight is monitored in real time as described below. Using the measured mass over various time points, an overall drying time was determined to have a roughly linear relationship in the drying process vs the initial mass. As such, in one or more embodiments, learned rates of moisture removal are determine using the algorithm for a line of y = mx + b formula, where y is material mass, x is drying time, and m and b are empirically learned based on the observed changes in tray mass over the drying period. A learned rate of moisture removal allows for determining a drying time based on an initial mass of a comestible cell-based meat product.

FIG. 4B illustrates data used to determine a learned rate of moisture removal. As mentioned above, the learned rate of moisture removal can be based on pressure and temperatures. For the example shown in FIG. 4B, the vacuum chamber pressure was approximately 4 Torr and the temperature was between 40-50° F. One will appreciate that the comestible cell-based meat product being vacuum dried is colder due to evaporative cooling. In the example, shown in FIG. 4B, the starting moisture content was 88.48% and the solids were 11.52%. The desired final moisture content is 75%. The initial mass of the comestible cell-based meat product is 227 g with 201 g being moisture and 26 g being solids. The desired final product will have 78 g/104 g of moisture and 26 g/104 g of solids. As such, the desired mass loss is the final mass minus the initial mass or (227 g - 104 g) = 123 g with the tray mass being 19 g. FIG. 4B shows various time points and the corresponding mass during vacuum drying. Repeating this process various times allows for determining a learned rate of moisture removal by fitting a line to the data. For the example, of FIG. 4B, the learned rate of moisture removal was determined to be M = -14.146(T)+245.403, where M is the mass in grams and T is the vacuum drying time in hours. Specifically, the foregoing algorithm is solved for T as T = (M-245.403) / -14.124. The learned rate of moisture removal allows for the determination of a vacuum drying time in hours given a desired final mass in grams. In particular, for the example described above, for a desired final mass of 142 g (123 g +19 g), the vacuum drying time in hours is 7.321 hours.

FIG. 4C illustrates data used to determine another learned rate of moisture removal. Similar to the example of FIG. 4B, the vacuum chamber pressure was approximately 4 Torr and the temperature was between 40-50° F. In the example, shown in FIG. 4C, the starting moisture content was 93.79% and the solids were 6.21%. The desired final moisture content is 75%. The initial mass of the comestible cell-based meat product is 399 g with 374 g being moisture and 25 g being solids. The desired final product will have 75 g/100 g of moisture and 25 g/100 g of solids. As such, the desired mass loss is the final mass minus the initial mass or (399 g - 100 g) = 299 g with the tray mass being 691 g. FIG. 4C shows various time points and the corresponding mass during vacuum drying. Repeating this process various times allows for determining a learned rate of moisture removal by fitting a line to the data. For the example of FIG. 4C, the learned rate of moisture removal was determined to be M = -45.914(T)+1093.310, where M is the mass in grams and T is the vacuum drying time in hours. Specifically, the foregoing algorithm is solved for T as T = (M-1093.310) / -45.914. The learned rate of moisture removal allows for the determination of a vacuum drying time in hours given a desired final mass in grams. In particular, for the example described above, for a desired final mass of 990 g (299 g + 691 g), the vacuum drying time in hours is 2.250 hours.

Thus, based on the learned rate of moisture removal and/or an initial mass (or other drying factor) of the comestible cell-based meat product, the predetermined amount of time 208 can be estimated. For example, the predetermined amount of time 208 can be determined by using the learned rate of moisture removal and the initial mass of the comestible cell-based meat product to identify a duration of vacuum drying that corresponds to a desired moisture content. For instance, the initial mass of the comestible cell-based meat product may indicate the starting point along a corresponding mass-time drying curve (e.g., a learned rate of moisture removal as a function of mass and time). The time difference between the starting point and a completion point (e.g., for a desired moisture content) equates to the predetermined amount of time 208.

The predetermined amount of time 208 can be estimated in other ways. For example, a machine-learning model trained to predict the predetermined amount of time 208 can be utilized. In one or more embodiments, a computing system utilizes the machine-learning model to predict the predetermined amount of time 208 based on the initial mass measurement (and/or other measurements or apparatus settings). It will be appreciated that such a machine-learning model can be trained based on training data (e.g., training mass data, training pressure data, etc.) to generate predicted amounts of time for partially drying a comestible cell-based meat product using a vacuum apparatus.

The computing system can compare the predicted amounts of time and ground truth drying times utilizing a loss function (e.g., an L1 or L2 loss function). In particular embodiments, the loss function comprises a regression loss function (e.g., a mean square error function, a quadratic loss function, an L2 loss function, a mean absolute error/L1 loss function, mean bias error). Additionally, or alternatively, the loss function includes a classification-type loss function (e.g., a hinge loss/multi-class SVM loss function, cross entropy loss/negative log likelihood function).

Based on the loss function, a loss (e.g., a quantitative difference between the predicted amounts of time and the ground truth drying times) can be utilized to update one or more learned parameters of the machine-learning model. In particular embodiments, a computing system adjusts various parameters to improve the quality/accuracy of the predicted amounts of drying time in subsequent training iterations-by narrowing the difference between the predicted amounts of drying time and the ground truth drying time in subsequent training iterations.

At the step 309, the vacuum drying process is initiated. This step is further described above in relation to FIG. 3.

At a step 408, a duration of drying the comestible cell-based meat product is determined to satisfy the predetermined amount of time 208. In particular embodiments, the step 408 comprises utilizing a timing device (e.g., a timer, stopwatch, clock, alarm, etc.) that measures or tracks time. The timing device can indicate that the duration of drying time has satisfied the predetermined amount of time 208 by counting down from (or up to) the predetermined amount of time 208. When the timing device indicates that a duration of drying time equating to the predetermined amount of time 208 has lapsed, the timing device can provide an audio and/or visual alert. Additionally, or alternatively, the timing device can cause the vacuum apparatus to stop drying the comestible cell-based meat product.

At a step 410, the vacuum drying process can be stopped in response to determining the duration of drying time satisfies the predetermined amount of time 208. In one or more embodiments, the step 410 is an automated step. For instance, the timing device can cause the vacuum apparatus to actuate one or more pressure regulators to flood the vacuum chamber with atmospheric gas. Alternatively, the step 410 is not automated. For example, the vacuum drying apparatus is manually stopped and brought out of vacuum. Upon ending the vacuum drying process, the partially-dried comestible cell-based meat product is removed from the vacuum chamber and corresponding drying tray in preparation for subsequent processing (e.g., raw meat packaging).

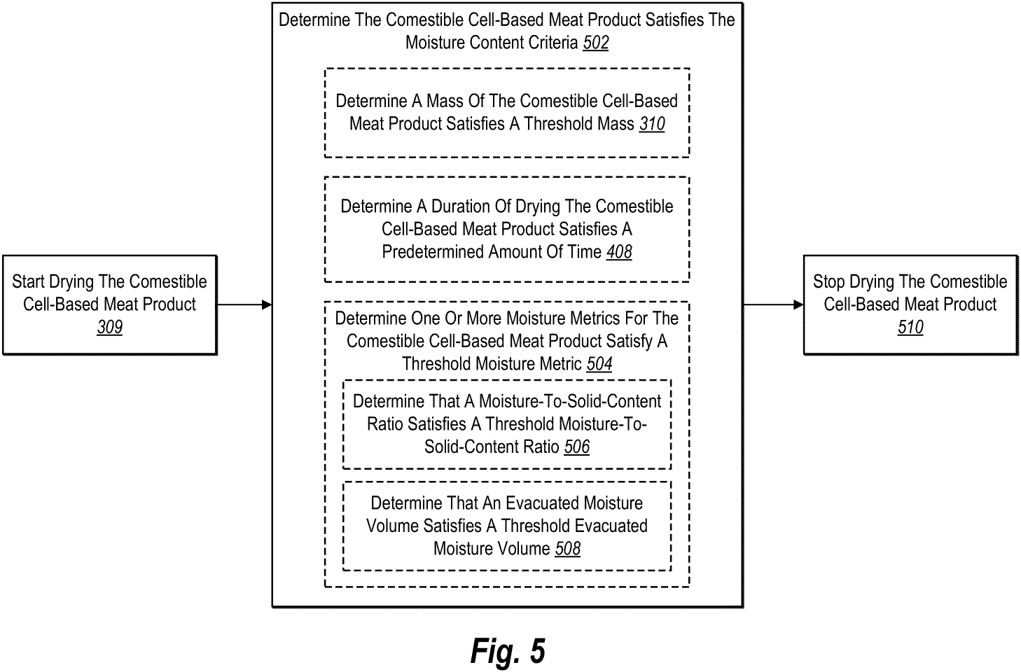

As mentioned above, in one or more embodiments, a moisture content criteria is utilized to determine when to stop vacuum drying a comestible cell-based meat product. In accordance with one or more embodiments, FIG. 5 illustrates a process of determining that a comestible cell-based meat product satisfies a moisture content criteria to trigger stoppage of a vacuum drying process.

At the step 309 of FIG. 5, the vacuum drying process is initiated. This step is further described above in relation to FIG. 3. At a step 502, the moisture content of the comestible cell-based meat product is determined to satisfy the moisture content criteria. The moisture content of the comestible cell-based meat product can satisfy the moisture content criteria in one or more different ways. For example, in some embodiments, the moisture content criteria is satisfied based on determining that a mass of the comestible cell-based meat product satisfies a threshold mass (e.g., as described above in relation to the step 310 of FIG. 3). That is, in certain implementations, the comestible cell-based meat product achieving a threshold mass as described above can be indicative of the comestible cell-based meat product achieving a certain moisture content that satisfies the moisture content criteria. In such a case, achieving the threshold mass can inherently mean that the moisture content criteria for the comestible cell-based meat product is satisfied.

As another example, in one or more embodiments, the moisture content criteria is satisfied based on determining that a duration of drying the comestible cell-based meat product satisfies a predetermined amount of time (e.g., as described above in relation to the step 408 of FIGS. 4). Specifically, in particular embodiments, the comestible cell-based meat product being dried for a predetermined amount of time can be used as a substitute indication that the comestible cell-based meat product comprises a moisture content satisfying the moisture content criteria. For example, by drying the comestible cell-based meat product for the predetermined amount of time, the moisture content criteria can inherently be satisfied.

At a step 504, one or more moisture metrics for the comestible cell-based meat product are determined to satisfy a threshold moisture metric. The step 504 can be performed in one or more different ways. For example, at least one of step 506 or step 508 is performed to determine that one or more moisture metrics for the comestible cell-based meat product satisfy a threshold moisture metric.

At the step 506, a moisture-to-solid-content ratio of the comestible cell-based meat product is determined to satisfy a threshold moisture-to-solid-content ratio. Measuring a moisture-to-solid-content ratio of the comestible cell-based meat product is described above in relation to FIG. 3. Indeed, the step 506 is similar to the step 306 described above in relation to measuring a pre-dried moisture-to-solid-content ratio of the comestible cell-based meat product. The difference at the step 506 is one of timing. In particular, at the step 506, the moisture-to-solid-content ratio can be measured at one or more intervals during the vacuum drying process as opposed to before the vacuum drying process. It will be appreciated that the step 506 does not preclude determining a pre-dried moisture-to-solid-content ratio of the comestible cell-based meat product before the vacuum drying process begins (e.g., to identify an initial gap between starting moisture content and desired moisture content).

In certain embodiments, one or more moisture gauges, moisture meters, moisture analyzers (e.g., a halogen moisture analyzer), near infrared analyzers, diode array analyzers, etc. are utilized to obtain a moisture reading of the harvested comestible cell-based meat product (or a sample thereof) after a certain period of time or at regular intervals of time. To do so, such moisture measurement(s) may be obtained in the vacuum chamber while under vacuum and digitally transmitted (e.g., to a computing device outside the vacuum chamber). In other embodiments, the moisture measurement(s) of the comestible cell-based meat product may be obtained during a drying pause outside of the vacuum chamber. The measured moisture-to-solid-content ratio is then compared to the threshold moisture-to-solid-content ratio.

It will be appreciated that the threshold moisture-to-solid-content ratio corresponds to a desired moisture-to-solid-content ratio following a vacuum drying process of the present disclosure. For example, the threshold moisture-to-solid-content ratio for a particular type of comestible cell-based meat product (e.g., a cell-based breast of chicken) corresponds to a user expectation of or actual moisture-to-solid-content ratio for a corresponding conventional slab of meat product being imitated (e.g., a chicken breast of a slaughtered chicken). To illustrate, the threshold moisture-to-solid-content ratio of the comestible cell-based meat product after being partially dried is in a range of about 2 to about 10 (e.g., 2:1-10:1).

At the step 508 (as an alternative to the step 506), an evacuated moisture volume is determined to satisfy a threshold evacuated moisture volume. In this embodiment, the evacuated moisture volume corresponds to a measured amount of water vapor evacuated from the vacuum chamber. The evacuated volume of moisture content can be captured in a measurement device configured to measure water density, a relative water humidity, or the specific volume of water vapor captured.

In turn, the measured amount of evacuated moisture volume or weight can be compared to a threshold evacuated moisture volume or weight. The threshold evacuated moisture volume or weight comprises an expected amount of moisture to be evacuated based on a pre-drying moisture-to-solid-content ratio or initial mass reading of the comestible cell-based meat product. Alternatively, at the step 508 (as an alternative to the step 506), a humidity reading within the vacuum apparatus or a combination thereof with an evacuated moisture volume is used. For example, rather than, or in combination with, measuring evacuated moisture volume or weight, a humidity within the vacuum apparatus is determined. The determined humidity can be compared to a threshold humidity associated with a desired moisture content criteria to determine if the comestible cell-based meat product has reached a desired drying point.

Additionally, or alternatively to the steps 506-508, one or more embodiments include using different moisture metrics than described above. For example, in certain implementations, a water activity is used as the moisture metric of choice. As used herein, the term “water activity” refers to the ratio of the water vapor pressure of the comestible cell-based meat product to the vapor pressure of pure water at the same temperature. In particular embodiments, water activity refers to the available water in the comestible cell-based meat product upon which microorganisms depend on for growth. It will therefore be appreciated that the step 504 can include determining that the water activity of the comestible cell-based meat product has been lowered to the range of about 0.95 to about 0.99 for fresh raw meat (e.g., from an initial water activity of about 1.0).

At a step 510, the vacuum drying process is stopped in response to determining that a moisture content of the comestible cell-based meat product satisfies a moisture content criteria. In one or more embodiments, the step 510 is an automated step. For instance, a moisture measurement device can cause the vacuum apparatus to actuate one or more pressure regulators to flood the vacuum chamber with atmospheric gas. Alternatively, the step 510 is not automated. For example, the vacuum drying apparatus is manually stopped and brought out of vacuum. Upon ending the vacuum drying process, the partially-dried comestible cell-based meat product is removed from the vacuum chamber and corresponding drying tray in preparation for subsequent processing (e.g., raw meat packaging).

As mentioned above, in one or more embodiments, a vacuum apparatus comprises a combination of components for partially drying a comestible cell-based meat product. FIGS. 6A-6B illustrate a vacuum apparatus 600 for partially drying a comestible cell-based meat product in accordance with one or more embodiments. In particular, FIG. 6A illustrates the vacuum apparatus 600 configured to receive a comestible cell-based meat product for partially drying. In contrast, FIG. 6B illustrates the vacuum apparatus 600 in operation to partially dry a comestible cell-based meat product. As shown, the vacuum apparatus 600 comprises a drying tray 602, a vacuum chamber 610, and a vacuum pump 612. The components of the vacuum apparatus 600 are now discussed in turn.

The drying tray 602 comprises a drying surface 606 configured to receive a comestible cell-based meat product 622. In one or more embodiments, the drying surface 606 is sized and shaped for receiving the comestible cell-based meat product 622. To illustrate, the drying surface 606 is sized and shaped to receive the comestible cell-based meat product 622 comprising a sheet of cell-adherent culture harvested from a bioreactor.

The drying tray 602 comprises a material that is compatible with vacuum drying the comestible cell-based meat product 622. For example, the drying tray 602 comprises stainless steel (e.g., an austenitic stainless steel, a ferritic stainless steel, a duplex stainless steel, a martensitic and precipitation hardening stainless steel, a passivated stainless steel). In particular embodiments, the drying tray 602 includes food grade stainless steel, such as grade 316 stainless steel, or grade 430 stainless steel (e.g., for enhanced corrosion resistance). Other metal-based materials may also be suitable for the drying tray 602. For example, in one or more embodiments, the drying tray 602 comprises titanium, aluminum, copper, nickel, etc., individually or combined in various alloys.

Additionally, or alternatively, the drying tray 602 comprises a biocompatible material and/or a corrosion resistant material. For instance, the drying tray 602 comprises one or more of polyolefins (e.g., polyethylene and polypropylene), polyvinyl chlorides, or fluoropolymers (e.g., polyvinylfluoride, polyvinylidene fluoride, polytetrafluoroethylene, polychlorotrifluoroethylene, perfluoroalkoxy polymer, fluorinated ethylene-propylene, polyethylenetetrafluoroethylene, polyethylenechlorotrifluoroethylene, perfluorinated elastomer, vinylidene-fluoride-based copolymers, tetrafluoroethylene-propylene, perfluoropolyether). In one or more embodiments, the drying tray 602 comprises silicone. In other embodiments, the drying tray 602 comprises material for a carbon-fiber component, a three-dimensional printed component, and/or an injection-molded component. Still, in other embodiments, the drying tray 602 comprises fibrous material (e.g., plant-based fibers) for providing a porous drying surface.

Optionally, in one or more embodiments, the drying tray 602 comprises perforations 604 in the drying surface 606. The perforations 604 comprise slits (e.g., molded, cast, machined, or micro-machined thru-slots, thru-holes, etc.) that span between the drying surface 606 and a bottom side 608 opposing the drying surface 606. The perforations 604 can be arranged in myriad different configurations (e.g., rows, shaped patterns, etc.). In addition, the perforations 604 can be spaced according to differing spacing configurations (e.g., evenly spaced or variable density spacing). Moreover, through the perforations 604, moisture may be evacuated from the comestible cell-based meat product 622 and out one or more portions of the bottom side 608. In this manner, a surface area of the comestible cell-based meat product 622 exposed to the vacuum chamber environment can be increased for more rapid, thorough moisture reduction.

Alternatively to the perforations 604, the drying surface 606 may include pores (or areas of porous material). Indeed, rather than slits, the drying surface 606 may be composed of a material through which moisture can seep through (but not the solid portions of the comestible cell-based meat product 622 itself) and be evacuated out the bottom side 608.

In addition, the vacuum chamber 610 is configured to receive the drying tray 602. For example, the vacuum chamber 610 is sized and shaped to receive the drying tray 602 (or multiple drying trays not shown). In addition, the vacuum chamber 610 comprises an open space defined by surrounding sidewalls and a closable door. Moreover, the vacuum chamber 610 comprises hermetic seals to facilitate pressure-temperature manipulation inside the vacuum chamber 610. For example, the vacuum chamber 610 is configured to lower the environmental pressure around the comestible cell-based meat product 622 and maintain a temperature of the comestible cell-based meat product 622 at a refrigeration temperature.

In FIG. 6B, the vacuum chamber 610 comprises a pressure-temperature environment 620 while under vacuum as shown in the pop-out phase diagram. As depicted, the pressure-temperature environment 620 is defined by pressure bounds 616 and temperature bounds 618. The pressure-temperature environment 620 therefore corresponds to the steam phase (as opposed to ice or liquid water). It will be appreciated that the pressure bounds 616 and the temperature bounds 618 are not limited to the values portrayed in FIG. 6B. Indeed, pressure bounds 616 can define an environmental pressure between about .001 atm to about .95 atm. Similarly, temperature bounds 618 can define a temperature environment of about -1C to about 10C.

Of course, the pressure-temperature environment 620 inside the vacuum chamber 610 can fluctuate as a function of time. However, it will also be appreciated that the pressure-temperature environment 620 can vary as a function of spatial dimensions within the vacuum chamber 610. For instance, the comestible cell-based meat product 622 may be at one refrigeration temperature, and the walls or door of the vacuum chamber 610 may be at another refrigeration temperature (e.g., that is higher or lower than the temperature of the comestible cell-based meat product 622). In certain implementations, one or more different barometers and thermometers inside the vacuum chamber 610 can measure the pressure-temperature environment 620 (e.g., inside the comestible cell-based meat product 622, at or near the surface of the comestible cell-based meat product 622, and/or elsewhere in the vacuum chamber 610).

Further shown in FIGS. 6A-6B, the vacuum chamber 610 optionally comprises a scale 614. The scale 614 comprises one or more of a food grade scale, industrial scale, ultra precision scale, bench scale, platform scale, floor scale, spring scale, hydraulic scale, load cell, strain gauge, high resolution balance, digital scientific balance, beam balance, etc. In this manner, the mass (or weight) of the comestible cell-based meat product 622 can be digitally transmitted and/or displayed during the vacuum drying process (as described above in relation to the step 312 of FIG. 3).

In addition, the vacuum apparatus 600 further comprises the vacuum pump 612. The vacuum pump 612 evacuates moisture from the vacuum chamber 610. Indeed, as moisture evaporates from the comestible cell-based meat product 622 while under vacuum, the vacuum pump 612 evacuates the moisture from the vacuum chamber 610.

It will be appreciated that the manner of moisture evacuation depends on the type of vacuum pump. In certain embodiments, the vacuum pump 612 comprises a positive displacement pump. For example, the vacuum pump 612 comprises a rotary vane pump, diaphragm pump, liquid ring, piston pump, scroll pump, Wankel pump, external vane pump, roots blower, multistage roots pump, Toepler pump, lobe pump, etc. In other embodiments, the vacuum pump 612 comprises a momentum transfer pump. For example, the vacuum pump 612 comprises a diffusion pump or a turbomolecular pump. Still, in other embodiments, the vacuum pump 612 comprises a regenerative pump, a venturi vacuum pump, a steam ejector, etc. Accordingly, in one or more embodiments, the vacuum pump 612 comprises a gas, electric, or other type of powered motor to perform the designed function of moisture evacuation.

Alternative methods of moisture removal are also herein contemplated. For example, in addition to or alternatively to the vacuum pump 612, the vacuum chamber 610 comprises desiccation beads (e.g., that are placed in the bottom of the vacuum chamber 610). The desiccation beads can absorb the moisture evaporated from the comestible cell-based meat product 622. An example of desiccation beads includes silica gel beads. Other examples of desiccation beads include activated charcoal, calcium sulfate, calcium chloride, and molecular sieves (typically, zeolites).

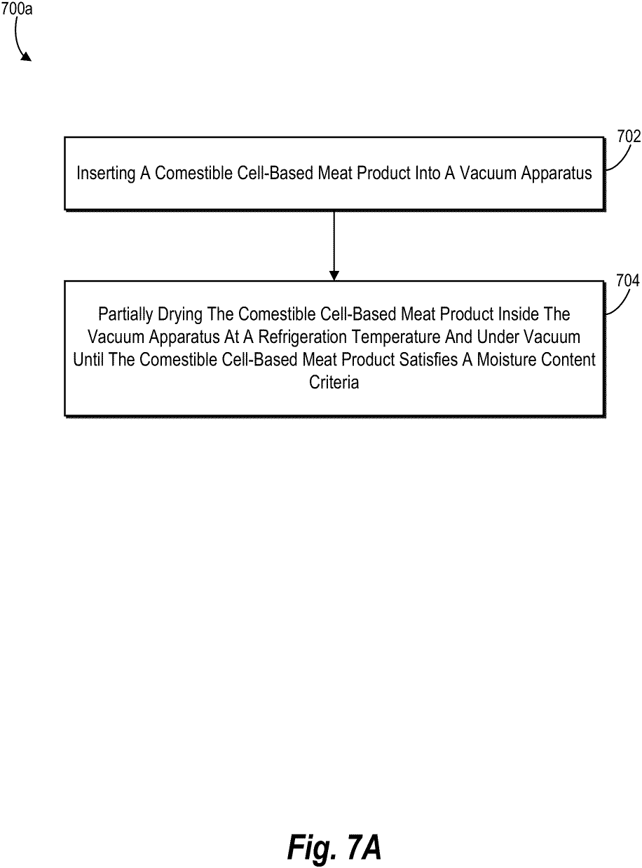

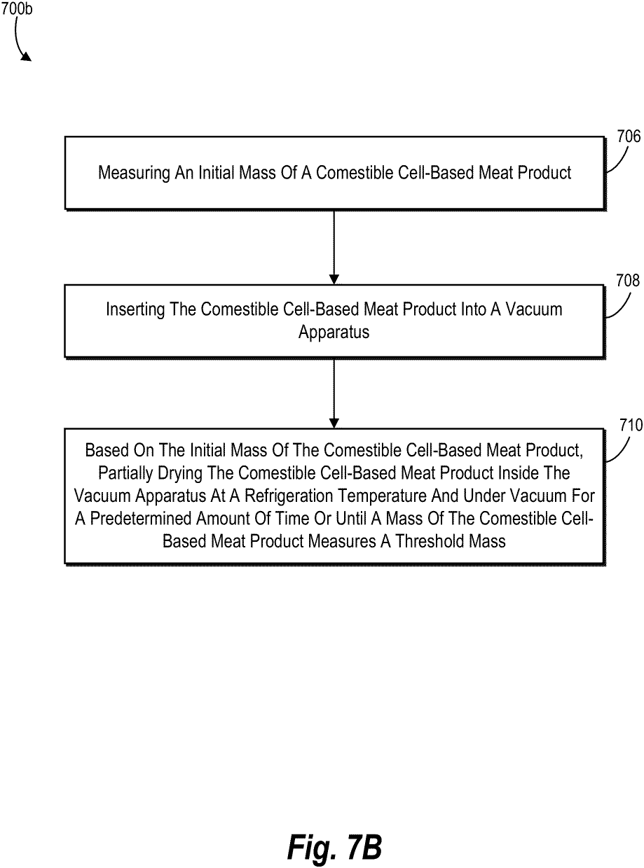

FIGS. 1-6B, the corresponding text, and the examples provide several different systems, methods, apparatuses, techniques, components, and/or devices relating to partially drying a comestible cell-based meat product in accordance with one or more embodiments. In addition to the above description, one or more embodiments can also be described in terms of flowcharts that include steps to perform vacuum drying as disclosed herein. For example, FIGS. 7A-7B illustrate flowcharts of a series of steps 700a-700b for vacuum drying a comestible cell-based meat product in accordance with one or more embodiments. The vacuum drying process of the present disclosure can be done according to one or more steps of the series of steps 700a-700b in addition to or alternatively to one or more steps described in conjunction with other figures. While FIGS. 7A-7B illustrate steps according to one embodiment, alternative embodiments may omit, add to, reorder, and/or modify any of the steps shown in FIGS. 7A-7B.

As shown in FIG. 7A, the series of steps 700a includes a step 702 of inserting a comestible cell-based meat product into a vacuum apparatus. The series of steps 700a also includes a step 704 of partially drying the comestible cell-based meat product inside the vacuum apparatus at a refrigeration temperature and under vacuum until the comestible cell-based meat product satisfies a moisture content criteria. In some embodiments, partially drying the comestible cell-based meat product comprises: drying the comestible cell-based meat product after being harvested from a bioreactor when the comestible cell-based meat product comprises a pre-drying moisture-to-solid-content ratio in a range of about 10 to about 20; and drying the comestible cell-based meat product until the comestible cell-based meat product satisfies the moisture content criteria comprising a post-drying moisture-to-solid-content ratio in a range of about 2 to about 10. Further, in one or more embodiments, partially drying the comestible cell-based meat product comprises drying the comestible cell-based meat product until configured for packaging as a raw meat product.

It is understood that the outlined steps in the series of steps 700a are only provided as examples, and some of the steps may be optional, combined into fewer steps, or expanded into additional steps without detracting from the essence of the disclosed embodiments. Additionally, the steps described herein may be repeated or performed in parallel with one another or in parallel with different instances of the same or similar steps. As an example, an additional or alternative step in the series of steps 700a may include a step of measuring an initial mass of the comestible cell-based meat product, wherein partially drying the comestible cell-based meat product comprises drying the comestible cell-based meat product inside the vacuum apparatus at the refrigeration temperature and under vacuum until the comestible cell-based meat product measures a threshold mass indicating the comestible cell-based meat product satisfies the moisture content criteria.

As another example, an additional or alternative step in the series of steps 700a may include a step of measuring a mass of the comestible cell-based meat product to identify whether the comestible cell-based meat product measures the threshold mass. For example, one or more embodiments involve measuring the mass of the comestible cell-based meat product at one or more predetermined time intervals (either inside the vacuum apparatus while under vacuum or outside of the vacuum apparatus).

As a further example, an additional or alternative step in the series of steps 700a may include a step of measuring an initial mass of the comestible cell-based meat product, wherein partially drying the comestible cell-based meat product comprises drying the comestible cell-based meat product inside the vacuum apparatus at the refrigeration temperature and under vacuum for a predetermined amount of time based on the initial mass of the comestible cell-based meat product. In certain embodiments, the predetermined amount of time is based on a learned rate of moisture removal associated with drying the comestible cell-based meat product.

In still another example, an additional or alternative step in the series of steps 700a may include a step of, after partially drying the comestible cell-based meat product, adding one or more agents to the comestible cell-based meat product to bind proteins in the comestible cell-based meat product.

As shown in FIG. 7B, the series of steps 700b includes a step 706 of measuring an initial mass of a comestible cell-based meat product. The series of steps 700b also includes a step 708 of inserting the comestible cell-based meat product into a vacuum apparatus. The series of steps 700b further includes a step 710 of, based on the initial mass of the comestible cell-based meat product, partially drying the comestible cell-based meat product inside the vacuum apparatus at a refrigeration temperature and under vacuum for a predetermined amount of time or until a mass of the comestible cell-based meat product measures a threshold mass. In one or more embodiments, partially drying the comestible cell-based meat product comprises drying the comestible cell-based meat product inside the vacuum apparatus at the refrigeration temperature and under vacuum until the mass of the comestible cell-based meat product measures the threshold mass to indicate satisfaction of a moisture content criteria for the comestible cell-based meat product. Further, in some embodiments, partially drying the comestible cell-based meat product comprises drying the comestible cell-based meat product inside the vacuum apparatus at the refrigeration temperature and under vacuum for the predetermined amount of time to satisfy a moisture content criteria for the comestible cell-based meat product.

It is understood that the outlined steps in the series of steps 700b are only provided as examples, and some of the steps may be optional, combined into fewer steps, or expanded into additional steps without detracting from the essence of the disclosed embodiments. Additionally, the steps described herein may be repeated or performed in parallel with one another or in parallel with different instances of the same or similar steps.

As an example, an additional or alternative step in the series of steps 700b may include a step of determining the threshold mass based on the initial mass of the comestible cell-based meat product, a measured or learned pre-drying moisture-to-protein/solid content ratio of the comestible cell-based meat product, and an estimated post-drying moisture-to-protein/solid content ratio of the comestible cell-based meat product. In certain embodiments, the measured or learned pre-drying moisture-to-protein/solid content ratio of the comestible cell-based meat product after being harvested from a bioreactor and prior to drying is in a range of about 10 to about 20. Further, in some embodiments, the estimated post-drying moisture-to-protein ratio of the comestible cell-based meat product after being partially dried is in a range of about 2 to about 10. Additionally, or alternatively, in certain implementations, determining the threshold mass of the comestible cell-based meat product is based on multiplying the initial mass of the comestible cell-based meat product by a quotient of the 1 minus the estimated pre-drying moisture-to-protein/solid content ratio and the 1 minus the measured or learned post-drying moisture-to-protein/solid content ratio of the comestible cell-based meat product.

In another example, an additional or alternative step in the series of steps 700a or 700b may include implementing an apparatus for partially drying a comestible cell-based meat product, the apparatus comprising: a drying tray having a surface sized and configured to hold a comestible cell-based meat product harvested from a bioreactor; a vacuum chamber to receive the drying tray, the vacuum chamber being configured to lower an environmental pressure around the comestible cell-based meat product and maintain a temperature of the comestible cell-based meat product at a refrigeration temperature; and a vacuum pump to evacuate moisture from the vacuum chamber.

In one or more embodiments of the apparatus, the vacuum chamber is configured to partially dry the comestible cell-based meat product until the comestible cell-based meat product satisfies a moisture content criteria or a threshold mass.

In one or more embodiments of the apparatus, the comestible cell-based meat product is refrigerated and under vacuum in the vacuum chamber for a predetermined amount of time based on an initial mass of the comestible cell-based meat product to satisfy the moisture content criteria.

Further, in one or more embodiments of the apparatus, the comestible cell-based meat product inside the vacuum chamber under vacuum is submitted to the environmental pressure of about 0.006 standard atmospheric pressure (atm) to about 0.0086 atm.

Still further, in one or more embodiments of the apparatus, the surface of the drying tray is perforated or porous to allow evacuation of the moisture from a bottom-side portion of the comestible cell-based meat product and through a bottom-side surface of the drying tray.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

As used herein, the terms “about” and “approximately” in reference to a given parameter, property, number, or condition mean within a degree of variance, such as within acceptable manufacturing tolerances or within a percent change of less than 10%. In some embodiments, the terms about” and “approximately” in reference to a given parameter, property, number, or condition mean within a percent change of less than 5%.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

The present invention may be embodied in other specific forms without departing from its spirit or essential characteristics. Indeed, the described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A method comprising:
inserting a comestible cell-based meat product into a vacuum apparatus; and
partially drying the comestible cell-based meat product inside the vacuum apparatus at a refrigeration temperature and under vacuum until the comestible cell-based meat product satisfies a moisture content criteria.

2. The method of claim 1, further comprising:
measuring an initial mass of the comestible cell-based meat product,
wherein partially drying the comestible cell-based meat product comprises drying the comestible cell-based meat product inside the vacuum apparatus at the refrigeration temperature and under vacuum until the comestible cell-based meat product measures a predetermined threshold mass based on the initial mass indicating the comestible cell-based meat product satisfies the moisture content criteria.

3. The method of claim 2, further comprising measuring a mass of the comestible cell-based meat product to identify whether the comestible cell-based meat product measures the predetermined threshold mass,
wherein measuring the mass of the comestible cell-based meat product comprises measuring the mass of the comestible cell-based meat product at one or more predetermined time intervals inside the vacuum apparatus while under vacuum or outside of the vacuum apparatus.

4. The method of claim 1, further comprising:
measuring an initial mass of the comestible cell-based meat product,
wherein partially drying the comestible cell-based meat product comprises drying the comestible cell-based meat product inside the vacuum apparatus at the refrigeration temperature and under vacuum for a predetermined amount of time based on the initial mass of the comestible cell-based meat product.

5. The method of claim 4, wherein the predetermined amount of time is based on a learned rate of moisture removal associated with drying the comestible cell-based meat product.

6. The method of claim 1, wherein partially drying the comestible cell-based meat product comprises:
drying the comestible cell-based meat product after being harvested from a bioreactor when the comestible cell-based meat product comprises a pre-drying moisture-to-solid-content ratio in a range of about 10 to about 20; and
drying the comestible cell-based meat product until the comestible cell-based meat product satisfies the moisture content criteria comprising a post-drying moisture-to-solid-content ratio in a range of about 2 to about 10.

7. The method of claim 1, further comprising determining the comestible cell-based meat product satisfies the moisture content criteria based, at least in part, on an amount of moisture evacuated from the vacuum apparatus.

8. The method of claim 1, wherein partially drying the comestible cell-based meat product comprises drying the comestible cell-based meat product until configured for packaging as a raw meat product.

9. The method of claim 1, further comprising:
after partially drying the comestible cell-based meat product, adding one or more agents to the comestible cell-based meat product to bind proteins in the comestible cell-based meat product.

10. The method of claim 1, further comprising determining the comestible cell-based meat product satisfies the moisture content criteria based, at least in part, on a humidity reading within the vacuum apparatus.

11. A method comprising:
measuring an initial mass of a comestible cell-based meat product;
inserting the comestible cell-based meat product into a vacuum apparatus; and
based on the initial mass of the comestible cell-based meat product, partially drying the comestible cell-based meat product inside the vacuum apparatus at a refrigeration temperature and under vacuum for a predetermined amount of time or until a mass of the comestible cell-based meat product achieves a threshold mass.

12. The method of claim 11, wherein partially drying the comestible cell-based meat product comprises drying the comestible cell-based meat product inside the vacuum apparatus at the refrigeration temperature and under vacuum until the mass of the comestible cell-based meat product measures the threshold mass to indicate satisfaction of a moisture content criteria for the comestible cell-based meat product.

13. The method of claim 11, wherein partially drying the comestible cell-based meat product comprises drying the comestible cell-based meat product inside the vacuum apparatus at the refrigeration temperature and under vacuum for the predetermined amount of time to satisfy a moisture content criteria for the comestible cell-based meat product.

14. The method of claim 11, further comprising determining the threshold mass based on the initial mass of the comestible cell-based meat product, a measured or learned pre-drying moisture-to-solid-content ratio of the comestible cell-based meat product, and an estimated post-drying moisture-to-solid-content ratio of the comestible cell-based meat product.

15. The method of claim 14, wherein:
the measured or learned pre-drying moisture-to-solid-content ratio of the comestible cell-based meat product after being harvested from a bioreactor and prior to drying is in a range of about 10 to about 20; and
the estimated post-drying moisture-to-solid-content ratio of the comestible cell-based meat product after being partially dried is in a range of about 2 to about 10.

16. The method of claim 14, wherein determining the threshold mass of the comestible cell-based meat product is based on multiplying the initial mass of the comestible cell-based meat product by a quotient of 1 minus an estimated pre-drying moisture content wet basis and 1 minus a measured or learned post-drying moisture content wet basis of the comestible cell-based meat product.

17. An apparatus for partially drying a comestible cell-based meat product, the apparatus comprising:
a drying tray having a surface sized and configured to hold a comestible cell-based meat product harvested from a bioreactor;
a vacuum chamber to receive the drying tray, the vacuum chamber being configured to lower an environmental pressure around the comestible cell-based meat product and maintain a temperature of the comestible cell-based meat product at a refrigeration temperature; and
a vacuum pump to evacuate volatiles, moisture, or a combination thereof from the vacuum chamber.

18. The apparatus of claim 17, wherein the vacuum chamber is configured to partially dry the comestible cell-based meat product until the comestible cell-based meat product satisfies a moisture content criteria or a threshold mass.

19. The apparatus of claim 18, wherein the comestible cell-based meat product is refrigerated and under vacuum in the vacuum chamber for a predetermined amount of time based on an initial mass of the comestible cell-based meat product to satisfy the moisture content criteria.

20. The apparatus of claim 17, wherein the comestible cell-based meat product inside the vacuum chamber under vacuum is submitted to the environmental pressure of about 0.006 standard atmospheric pressure (atm) to about 0.0086 atm.

21. The apparatus of claim 17, wherein the surface of the drying tray is perforated or porous to allow evacuation of the moisture from a bottom-side portion of the comestible cell-based meat product and through a bottom-side surface of the drying tray.
